(19) United States
(12) Patent Application Publication
(10) Pub. No.: US 2025/0217130 A1
(43) Pub. Date: Jul. 3, 2025

(54) TECHNIQUES OF PACKAGE DEPLOYMENT ON BMC

(71) Applicant: American Megatrends Internatioanal, LLC, Duluth, GA (US)

(72) Inventors: CHITRAK GUPTA, Kolkata (IN); Venkatesant Balakrishnan, Chennai (IN); Hari Venkatachalam, Bengaluru (IN); Manoj Ashok, Irugur (IN); Anurage Bhatia, Sugar Hill, GA (US)

(21) Appl. No.: 18/403,036

(22) Filed: Jan. 3, 2024

(51) Int. Cl. G06F 8/65; G06F 9/54

(52) U.S. Cl. CPC G06F 8/65; G06F 9/547

(57) ABSTRACT

In an aspect of the disclosure, a method, a computer-readable medium, and an apparatus are provided. The apparatus is a BMC. The BMC receives, via an application programming interface (API) at the BMC, a package management request for managing a software component of the BMC. The BMC determines, by a package management service of the BMC, whether a software package for the software component is an updatable package to be stored on a read-write partition of a storage of the BMC. When the software package is the updatable package, the BMC manages the software component according to the package management request.

### BACKGROUND

### Field

The present disclosure relates generally to computer systems, and more particularly, to techniques of deploying software packages to a baseboard management controller (BMC).

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v. 2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture. The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is a BMC. The BMC receives, via an application programming interface (API) at the BMC, a package management request for managing a software component of the BMC. The BMC determines, by a package management service of the BMC, whether a software package for the software component is an updatable package to be stored on a read-write partition of a storage of the BMC. When the software package is the updatable package, the BMC manages the software component according to the package management request.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system.

FIG. 2 is a diagram illustrating a BMC implementation.

FIG. 3 is a diagram illustrating a package file format supported by a package management service.

FIG. 4 is a diagram illustrating a storage of the BMC.

FIG. 5 is a flowchart of an updating process performed by the BMC.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

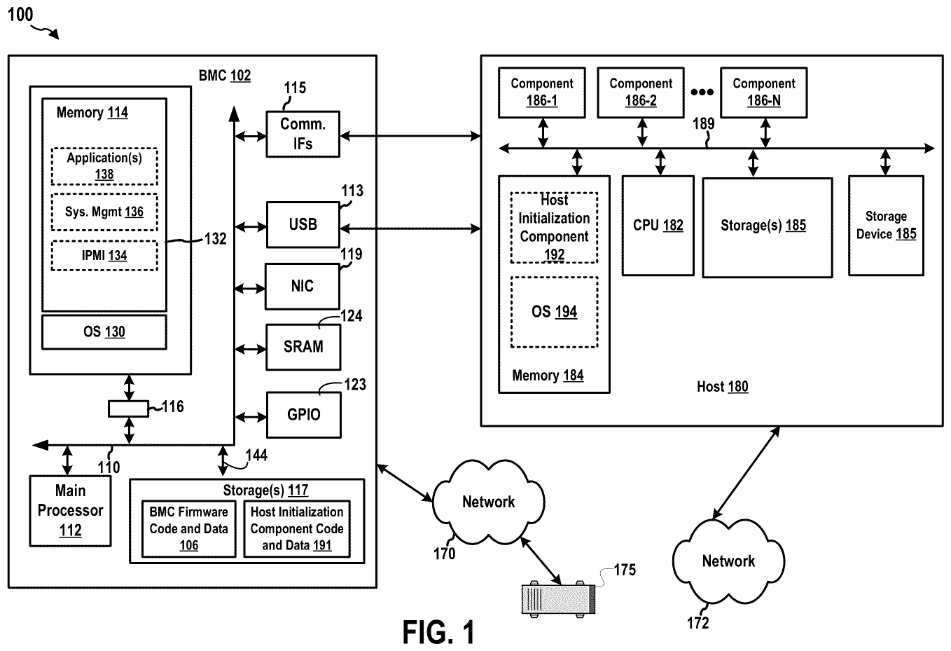

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 though the communication interfaces 115 and the communication channel 110. The host initialization component code and data 191 contains an initialization component 192. The host CPU 182 executes the initialization component 192. In one example, the initialization component 192 is a basic input/output system (BIOS). In another example, the initialization component 192 implements a Unified Extensible Firmware Interface (UEFI). UEFI is defined in, for example, “Unified Extensible Firmware Interface Specification Version 2.6, dated January 2016,” which is expressly incorporated by reference herein in their entirety. As such, the initialization component 192 may include one or more UEFI boot services.

The initialization component 192, among other things, performs hardware initialization during the booting process (power-on startup). For example, when the initialization component 192 is a BIOS, the initialization component 192 can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component 192 then initializes the device on which it is located. When the initialization component 192 includes UEFI boot services, the initialization component 192 may also perform procedures similar to POST.

After the hardware initialization is performed, the initialization component 192 can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170.

Further, the storage(s) 117 is in communication with the communication channel 110 through a communication link 144.

The BMC firmware code and data 106 and the host initialization component code and data 191 stored in the storage(s) 117 may contain sensitive information such as authentication keys, user information, and host information. Unauthorized access to this sensitive information could compromise the security of the server. Typically, server administrators implement security measures to restrict access to this sensitive data.

However, when a server is decommissioned, the storage devices may be removed or data may be erased without proper precautions. The flash memory chips containing the BMC firmware code and data 106 and the host initialization component code and data 191 are often overlooked during decommissioning. An attacker with physical access to these discarded flash memory chips can easily extract the sensitive data.

Recently, source code for many BMC and BIOS firmware has been open sourced (e.g., Open BMC and Open UEFI). This allows attackers to more easily decode the extracted firmware images. For case of administration, servers within a datacenter often use identical BMC and BIOS firmware. Thus, compromised firmware from one discarded server could expose all servers in that datacenter.

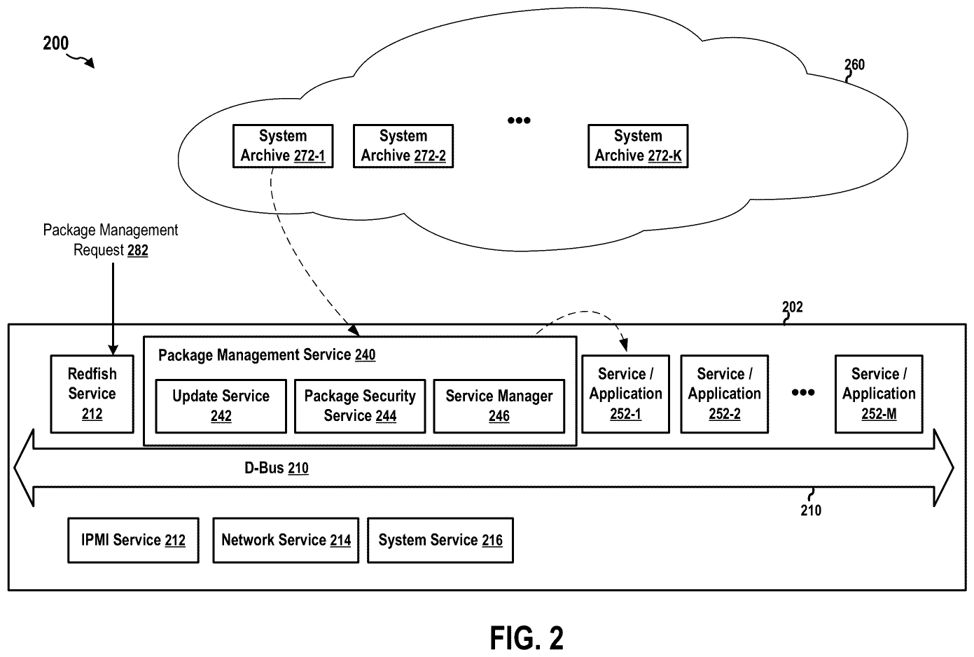

FIG. 2 is a diagram 200 illustrating a BMC implementation. A BMC 202 is an implementation of the BMC 102. The BMC 202 executes, among other services/applications, an IPMI service 212, a network service 214, a system service 216, a REDFISH service 222, a package management service 240, services/applications 252-1, 252-2, . . . , 252-M. A cloud storage 270 stores system archives 272-1, 272-2, . . . , 272-K. Each of the system archives 272-1, 272-2, . . . , 272-K is a secure location where updatable packages of a corresponding service/application (e.g., one of the services/applications 252-1, 252-2, . . . , 252-M) of a BMC are kept. Further, the package management service 240 includes an update service 242, a package security service 244, and a service manager 246.

The REDFISH service 222 serves as the bridge between remote management actions and the BMC 202, enabling cloud-based package management in a secure and standard manner.

The REDFISH service 222 allows external components to interact with and send commands to the BMC 202. The REDFISH service 222 implements a RESTful interface and may utilize standard HTTP(S) and JSON to provide access to data center hardware management functions.

The REDFISH service 222 provides the REDFISH API, which is the mechanism of communication between a remote management console and the BMC 202 for package management-related operations. The operations may include activities such as installing new software, updating existing software, or removing software from the system.

Original Equipment Manufacturer (OEM) REDFISH APIs are extensions made to the REDFISH standard. The REDFISH service 222 implements certain OEM REDFISH APIs to facilitate the package management service 240, which is responsible for deploying updates to the BMC 202 at runtime without requiring a full system reboot or firmware upgrade.

REDFISH creates a standardized, secure, and scalable interface for systems management. By extending the standard REDFISH schema with OEM-specific properties and methods, the REDFISH service 222 can provide custom functionalities beyond the core REDFISH model. These OEM extensions can include additional APIs necessary for the package management service 240.

Using OEM extensions to REDFISH, users or administrators can issue commands from their management consoles or remotely via secure HTTP requests. These commands could be to check for package updates, initiate installation or removal of packages, and query the status of package deployments. Commands are formatted according to the REDFISH specifications and include OEM-specific instructions for the package management service 240.

Once a command is issued to the REDFISH service 222 through the OEM REDFISH APIs, the command is received by the REDFISH service endpoint. The REDFISH service 222 interprets the request, performs any necessary authentication and authorization checks, and passes the command details to the package management service 240. For example, the REDFISH service 222 may pass the command details to the package management service 240 via the D-bus 210.

As such, through the OEM REDFISH APIs provided by the REDFISH service 222, operators or automated systems can send specific package management commands to the BMC 202 to manage packages. These commands may be packaged as API calls (typically HTTP requests) that conform to the REDFISH standard.

Once the package management commands are sent through the REDFISH interface, they are received by the package management service 240 running on the BMC 202. The package management service 240 is responsible for initiating and managing the actions requested through the REDFISH API calls. In particular, the package management service 240 interacts with the cloud storage 270. It is from this repository that the package management service 240 will fetch the software packages needed for installation or updates.

The package management service 240 of the BMC 202 has the capability to install, remove, and upgrade packages during the runtime of the system. The cloud storage 270 provides packages that can be installed or updated on the BMC 202. Similar to the functionality available in Linux distributions, a user can use package management commands such as “apt install <pkg-name>” to manage (e.g., install, updat, or remove) software packages. This functionality is made possible through the use of the REDFISH Software Installation service of the REDFISH service 222, as described supra.

The package management service 240 supports various package file formats for software deployment within the BMC 202. For example, RPM (Red Hat Package Manager) and DEB (Debian package) may be supported. RPM and DEB are common packaging formats used in Linux distributions for managing individual software packages, which contain the executable, configuration files, and metadata relevant to the software. This conformity to widely adopted packaging standards facilitates interoperability and the use of established tools and practices in package management.

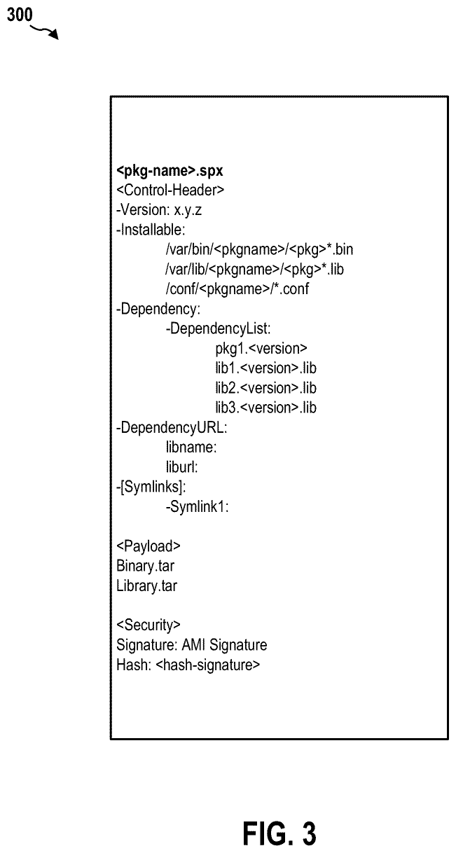

FIG. 3 is a diagram 300 illustrating another package file format supported by the package management service 240. The format, denoted as <pkg-name>.spx, encapsulates necessary components for installing, upgrading, or managing services and applications such as the IPMI service 212, network service 214, system service 216, and/or services/applications 252-1, 252-2, . . . , 252-M.

The <Control-Header> of the package file includes metadata that describes the version—Version: x.y.z, the installable file paths for binaries and libraries

/var/bin/<pkgname>/<pkg>*.bin, /var/lib/<pkgname>/<pkg>*.lib, and configuration files/conf/<pkgname>/*.conf. This structure corresponds to the Linux file system hierarchy, ensuring compatibility and case of administration for the BMC 202. It allows the update service 242 to locate and manage these files upon installation or updates.

Dependencies are outlined within the package file format denoted by -Dependency:. This section lists dependent packages and libraries -DependencyList: with specific versions required for the package. External dependencies can be fetched as the format specifies the appropriate URLs under -DependencyURL:. This facilitates the service manager 246 in ensuring all components are present before installation or updates, procuring from sources like liburl: if necessary.

Symlinks (-[Symlinks]:), a feature of Unix-like filesystems, are supported, allowing software to maintain a consistent interface or backward compatibility without duplicating files. The -Symlink1: creates an alias or shortcut to another file, useful when the package contains executable binaries accessed from a common or legacy path.

The <Payload> section houses core content in Binary.tar and Library.tar. These archives comprise the executable code and libraries packaged to save space and expedite downloads from cloud storage 270, where the system archives 272-1, 272-2, . . . , 272-K are maintained securely. Security is specified in the <Security> section, with an Signature1 and Hash: <hash-signature> for source and integrity verification. The package security service 244 uses these to authenticate the package before installation on BMC 202.

The REDFISH service 222, through OEM REDFISH APIs, serves as a conduit for package management, allowing remote actions over the network. Once a command is received, the package management service 240 retrieves the package from cloud storage 270 and performs necessary operations using the metadata and content within the <pkg-name>.spx package file format, providing a flexible and secure system for runtime deployment of applications.

Each package from the cloud storage 270 is digitally signed and secured. This allows the package management service 240 to verify that the package has not been tampered with and that it originates from a trusted source.

The package management service 240 uses the package security service 244 to ascertain the security of the package before deploys them. For example, the package security service 244 may check the integrity and authenticity of the software packages by examining digital signatures and other security credentials before the packages are deployed to the BMC 202.

The package management service 240 is responsible for managing software dependencies, which are other packages or libraries a software package might require to function appropriately. If a required dependency is missing or incompatible, the package management service 240 will attempt to address the issue, and in the event of a failure, it will provide error messages to inform the administrator about the nature of the problem. When a package requires a specific dependency not currently available on the BMC system, the package management service 240 can fetch and install the dependency from a specified URL if it is accessible, thus ensuring that the primary software package can be successfully installed or updated.

The package update/installation is an asynchronous operation and is not blocking. The operation can proceed in the background without halting the operation of the BMC 202. During this time, the status of the installation can be checked using the REDFISH service API provided by the REDFISH service 222.

As described supra, the package management service 240 includes the update service 242, the package security service 244, and the service manager 246. The update service 242 serves as the initial point of contact for managing software updates within the BMC 202. The update service 242 receives software packages for deployment. When a package is sent from REDFISH service 222 or the cloud storage 270, the update service 242 is responsible for parsing the package's metadata and managing any associated licenses. This metadata includes information necessary for the correct installation and validation of the package such as version numbers, dependency requirements, and installation paths.

Upon receipt of a package, the update service 242 consults the package security service 244 to verify the package's integrity and ensure that it is secure before moving forward with the deployment process. Only after receiving confirmation from the package security service 244 does the update service 242 proceed to copy the package files to the appropriate locations within the BMC's filesystem.

The package security service 244 operates as a safeguard within the package management service 240. Its primary role is to ensure the authenticity and integrity of any received software package. Once a package is received, this service validates the package by checking the digital signatures against known secure signatures to confirm that it has not been tampered with and that it stems from a verified source. This security measure aims to prevent unauthorized or malicious code from being introduced into the BMC 202. Only packages that pass this stringent security check are considered for installation by the update service 242.

After the update service 242 has placed the package files in the correct filesystem locations, the service manager 246 initializes the new or updated services and manages the services throughout their lifecycle. This component manages systemd unit files, which are configuration files for systemd, and keeps them running as needed. systemd is the initialization system in Linux that manages the starting of tasks and services during boot.

The service manager 246 aims to ensure that any newly installed or updated services are correctly initialized and configured to start when required, that they can be stopped or restarted as needed, and that, should any service fail, appropriate actions are taken according to the defined policy for that service (e.g., restarting the service, logging the incident, notifying administrators, etc.).

The service manager 246 handles any dependencies that the package may require. For instance, if package A is dependent on package B, and package B is not present or requires updates, the service manager 246 will handle this by initiating the necessary processes to install or update package B as well. Efficient dependency management ensures that all the components necessary for the successful execution of a package are available and compatible, which is crucial for maintaining the stability of the BMC's operations.

In managing the lifecycle of these processes and associated services/applications 252-1, 252-2, . . . , 252-M, the BMC 202 employs systemd, which is a component of the underlying Linux system on which BMC 202 operates. Systemd is a system and service manager that administers the initialization and maintenance of services, encapsulating functionalities such as starting, stopping, restarting, and managing dependencies between services. Through systemd, the BMC 202 ensures that services can automatically recover from temporary failures and continue to operate without causing system-wide interruptions. This allows for a resilient and robust service environment on the BMC 202, compatible with the requirements of high-availability systems within data center infrastructure.

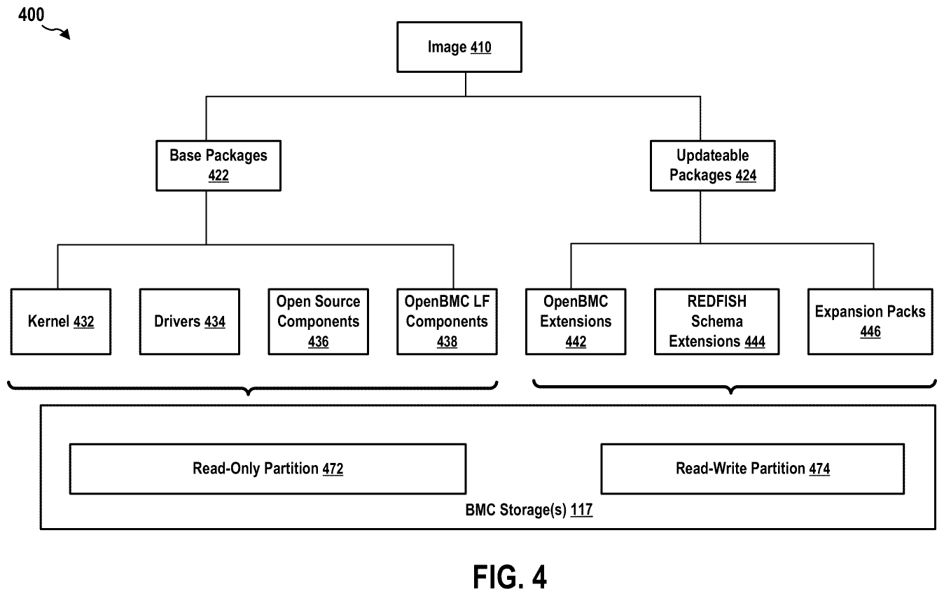

FIG. 4 is a diagram 400 illustrating a storage of the BMC 202. The BMC 202 is an implementation of the BMC 102. In this implementation, the storage(s) 117 of the BMC 202 may contain two or more partitions, including a read-only partition 472, such as a squashFS partition, and a read-write partition 474 such as a JFFS2/EXT partition. SquashFS partition is a compressed read-only file system that minimizes the use of limited flash storage space on the BMC hardware.

A firmware image 410 of the BMC 202 may include two types of packages: base Packages 422 and updateable Packages 424.

The base packages 422 may include, among others, core system software components that provide foundational functionality for the BMC 202. This includes the kernel 432, device drivers 434, open source components 436, and OpenBMC Linux Foundation (LF) components 438 required for basic operation. As core elements, these packages are not meant to be updated individually because doing so could compromise system stability due to potential dependency issues. Instead, updates to these components typically necessitate a full firmware upgrade or system reboot, as they are integral to the entire operation of BMC 202.

The base packages 422 may be obtained from community GIT repositories, ensuring they are in line with the latest secure and stable versions provided by the open-source community. The base packages 422 may be packaged in a monolithic manner within the read-only partition 472.

The updateable packages 424 may include OpenBMC extensions 442, Redfish schema extensions 444, and Expansion Packs 446. These packages provide additional functionality that can be modified or extended post-deployment without the need for system-wide updates or reboots.

In contrast to the base packages 422, the updateable packages 424 are hosted in a read-write partition, such as JFFS2 or EXT2/3/4 file systems, which allows them to be individually upgradable. During the build process of the BMC firmware image, specific instructions or macros in the software recipes distinguish updateable components from base components. These macros precisely instruct the build process to allocate the updateable packages to the read-write partition 474, enabling runtime upgrades and installations.

The dependency management for the base packages 422 is relatively straightforward since these components are updated as a singular group during a firmware upgrade. The system relies on the integrity of collective updates typically sourced from stable community releases.

However, for the updateable packages 424, dependency management becomes a more localized matter given that these packages can be individually updated. as described supra, the package management service 240 provides the necessary functionality to manage dependencies. The package management service 240 maintains the security and integrity of the updateable packages, manages their dependencies, and ensures they are updated seamlessly, without causing system disruptions or incompatibility issues.

The updateable packages 424 can be serviced via remote commands, as the REDFISH service 222 acts as the intermediary, receiving update requests and triggering the update service 242. In certain configurations, the package management service 240 references the cloud storage 270 to retrieve and deploy newer versions of these packages.

In certain configurations, the storage(s) 117 is a SPI FLASH storage device. The root file system (Rootfs) of the BMC 202 uses separate storage partitions on the SPI FLASH to manage the components of base packages 422 and updateable packages 424. When the firmware image 410 is being installed on the BMC 202, the base packages 422 are stored in a read-only partition, specifically a SquashFS partition. The SquashFS partition, being compressed and read-only, is utilized for its efficiency in utilizing limited flash storage space. The base packages 422 include crucial elements such as the kernel image and drivers that ensure the basic functionality of the BMC 202.

Conversely, the updateable packages 424 are stored in a read-write partition, which could be a JFFS2 or an EXT partition. This design allows these packages to be individually upgraded at runtime, providing a more dynamic and flexible framework for maintaining and enhancing the BMC's software without the traditional risk of downtime. Storing these files in a dedicated read-write partition (JFFS2/EXT) allows for the on-the-fly updates.

When determining the storage partition for a package, the package management service 240 first checks if the package is updateable. For the base packages 422, which are not designated as updateable, the package management service 240 relocates the base packages 422 to the read-only partition 472, which is the SquashFS partition, where they reside in the/bin or/lib directories.

In contrast, for the updateable packages 424, the package management service 240 stores the packages in the read-write partition 474, such as a JFFS2 or an EXT file system partition, within paths such as/var/bin, /var/lib, and/conf.

In certain configurations, the BMC 202 may utilize embedded multimedia cards (EMMC) to host the root file system (Rootfs). The EMMC provides sizeable non-volatile storage capacity in a compact form factor, valuable for embedded systems such as the BMC 202.

The EMMC-based Rootfs can adhere to a single partitioning structure. This simplifies the partition management since all files are stored within the same partition, allowing read and write operations without the constraints of separate partitions.

An EXT3 file system on EMMC can serve as the lone partition hosting rootfs on BMCs. The EXT3 file system is a journaled file system, providing added security against data corruption and allowing for a robust handling of read-write operations, which is important for the execution and update of updateable packages 424 during run-time.

When employing an EMMC-based single partitioning structure formatted with the EXT3 file system, all packages can coexist on the same R/W partition. This unified partitioning schema can be accessed and managed by the package management service 240.

Referring back to FIG. 2, in this example, the REDFISH service 222 receives a package management request 282 for updating a particular service/application 252-2 (or other service/application of the BMC 202). The REDFISH service 222 transfers details of the package management request 282 to the package management service 240. The package management service 240 determines that the service/application 252-2 is part of the updateable packages 424. The package management service 240 then checks the cloud storage 270 for specific system archives 272-1, 272-2, . . . , 272-K, verifying the presence, versions, and integrity of updateable packages for the service/application 252-2. The package management service 240 ascertains that the repositories contain the correct versions of software, correlating with the service/application 252-2 running on BMC 202.

The update service 242 of the package management service 240 constantly monitors the cloud storage 270 for the availability of new updates for the updateable packages 424. When newer versions are present, the update service 242 discerns the relevance of each update in accordance with the current service iterations, thus ensuring the BMC 202 maintains an up-to-date operational state.

Once the need for an update or a new installation is identified, or a removal is requested, the package management service 240 initiates the corresponding process. In this example, the update service 242 determines that updating the service/application 252-2 is requested.

Further, external management systems can proactively monitor the update status via mechanisms outside of the BMC, potentially utilizing OEM-specific extensions of Redfish APIs to receive notifications about the availability of package updates. To enhance the management efficiency, a policy can automate updates, directed by predetermined conditions or schedules. In the eventuality that a new package or an update adversely impacts the BMC 202 performance or stability, there exists a contingency to revert or rollback to previous iterations.

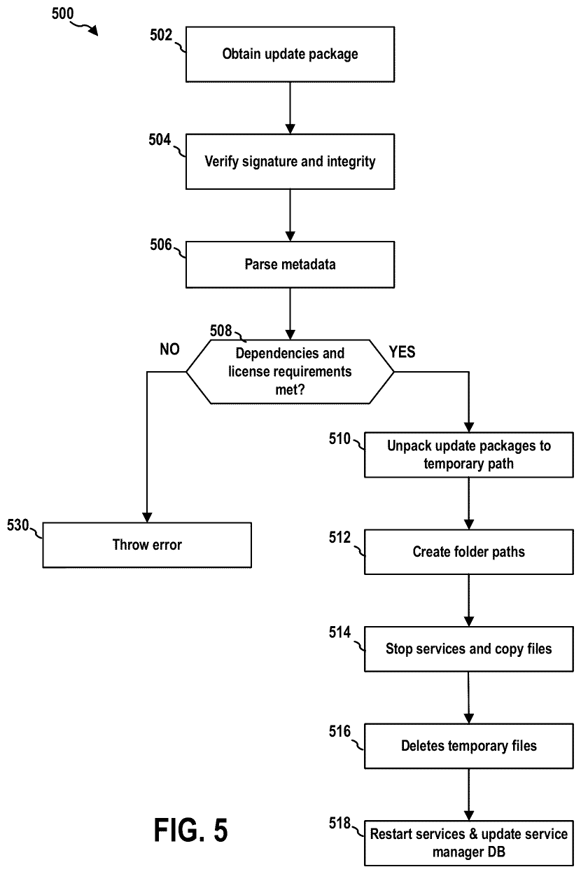

FIG. 5 is a flowchart 500 of an updating process. In operation 502, the update service 242 of the package management service 240 obtains an update package for a particular service/application to be updated (e.g., the service/application 252-2)

In operation 504, the package security service 244 validates the authenticity of the incoming packages through the verification of signatures and integrity checks. The package security service 244 may check checksums for integrity verification, and digital signatures for security validation. If the verification is successful, in operation 506, the service manager 246 parses metadata contained in the update package.

The metadata, embedded within the update package, encapsulates essential information that informs the service manager 246 about the specifics of the package, such as its version number, dependency requirements, installation paths.

The service manager 246 may unpack and read various control files, headers, or manifest lists within the update package's content. This metadata parsing allows the service manager 246 to discern whether the current environment of the BMC 202 is apt and ready for receiving the update.

Further, parsing the metadata also assists the service manager 246 in understanding the specific requirements of the package, such as the system resources it requires and any services/applications 252-1, 252-2, . . . , 252-M it needs to interact with. Accordingly, the service manager 246 may determine system directories and file paths where the update package's contents will reside.

In operation 508, the service manager 246 evaluates the dependency and license requirements, ensuring that no conflicts arise during the package deployment. As described supra, dependencies indicate other software packages or libraries that the service/application being updated depends upon for its proper execution. Licensing refers to the legal permissions and restrictions associated with the service/application.

During this evaluation procedure, the service manager 246 checks whether all dependencies listed for the service/application being updated are already present on BMC 202 and are compatible with the version of the software being managed. This includes both system-level dependencies for base packages 422 stored in the read-only partition 472 and application-level dependencies for the updateable packages 424 stored in the read-write partition 474.

Additionally, the evaluation ensures that the licenses of the service/application are updated and its dependencies do not conflict with the BMC's policies or legal requirements. The significance of verifying licenses lies in complying with software usage terms, which could dictate specific conditions under which the software can be used, distributed, or modified.

If any of the dependencies are missing or if there are conflicts or issues with the licenses, the update service 242 is informed, which subsequently responds by either attempting to resolve the issues by fetching missing dependencies from the cloud storage 270, updating incompatible ones, or aborting the installation or update process. Such a resolution may include automatically downloading the necessary dependencies from specified URLs as provided in the package metadata, thus ensuring that the new or updated software package can be successfully installed or updated on BMC 202.

Should the criteria in operation 508 be met, in operation 510, the service manager 246 progresses to unpack the update package, as temporary files, into a temporary path.

In operation 512, the service manager 246 creates folder paths within the read-write partition 474, following a conventional Linux filesystem hierarchy. This may include paths like /var/bin/ for binary executables, /var/lib/ for libraries, and /conf/ for configuration files specific to the service or application being deployed, such as services/applications 252-1, 252-2, . . . , 252-M.

In operation 514, the service manager 246 stops services to be updated while new files get copied over to the designated locations indicated by the file paths. In operation 516, the service manager 246 deletes the temporary files. In operation 518, the service manager 246 restarts the services that are stopped and updated. The service manager 246 then updates its database to reflect the changes to the system.

Conversely, should the packages not fulfill the requisite criteria during the integrity or dependency checks in operation 508, the service manager 246 throws an error in operation 530. The operation is then aborted.

Referring back to FIG. 2, in another example, the service/application 252-1, which is a third party application, is to be installed on the BMC 202. Further, in the example, the packages of the service/application 252-1 in stored in the system archive 272-1 in the cloud storage 270.

The deployment of the system archive 272-1 onto the read-write partition 474 is facilitated by the package management service 240. The kernel of the BMC firmware provides CHROOT jailed services. The service manager 246 utilizes the CHROOT jailed services to create an encapsulated environment where third-party applications can operate without compromising the core system functions of the BMC 202.

The CHROOT jailed services change the apparent root directory for the current running process and its children. This operation is often used to create an isolated environment, sometimes referred to as a “jail,” which is separate from the main system. Any process running in a “chroot” jail can only access files within its designated directory tree and not the directories outside it. Through this mechanism, “chroot” provides a way to limit the scope of potential damage that a process might cause.

Utilizing a CHROOT jail encapsulates third-party services/applications within a bounded environment. This method leverages Linux namespaces, creating an isolation layer that provides localized network settings and read-only mounts. Third-party applications developed for the BMC 202 are restricted in their interactions with the broader system, mitigating the risk of common vulnerabilities such as memory leaks, buffer overflows, and the results of insecure coding practices.

In this example, the package security service 244 of the package management service 240 checks the proper signing and integrity of the binary package of the system archive 272-1. This ensures that the application originates from a trusted source. The service manager 246 assesses the service/application 252-1's reliance on other system components or libraries to determine compatibility and functional coherence within the system archive 272-1.

The service manager 246 further checks the metadata in the system archive 272-1. The metadata enables the package management service 240 to understand the package's structure and requirements, thereby facilitating accurate deployment within the read-write partition 474 of the BMC 202.

All interactions between the service/application 252-1 (or other third-party applications) and the BMC 202 environment, including the IPMI service 212, the network service 214, and the system service 216 etc., are through specified APIs.

Configurations are sent to the service/application 252-1 via the REDFISH service 222's APIs, thus negating direct file system access. This established method of communication ensures that configurations are only changed through approved channels, preserving system integrity and preventing unauthorized modifications.

Further, through the REDFISH service 222, operators can initiate requests to install or manage third-party services/applications. These requests are handled by the package management service 240 and executed within the constraints of the CHROOT jail environment. By leveraging cloud storage 270 and the associated system archives 272-1, 272-2, . . . , 272-K, the package management service 240 can retrieve and deploy third-party packages effectively within the secure boundaries of the CHROOT jailed services framework.

Referring back to FIG. 2, in yet another example, the service/application 252-1, which is a third party application, is to be installed on the BMC 202. Further, in the example, the packages of the service/application 252-1 in stored in the system archive 272-1 in the cloud storage 270.

The BMC 202 supports deploying third party applications in containerized environments to provide isolation and prevent instability. Specifically, the BMC 202 has support for standard Linux container (LXC) and systemd-nspawn container runtimes. These can be leveraged to sandbox untrusted third party application code (e.g., the service/application 252-1). Containerization involves encapsulating an application in a container with its own operating environment, thus packaging an application with all the necessary components, like libraries and other dependencies, needed to operate.

When the system archive 272-1 (i.e., a third party application package) is obtained by the package management service 240, if it is designated as an untrusted application, the service manager 246 can initiate launching it within a containerized environment. The container would include a complete Linux root file system constituting the entirety of system files necessary to emulate a full-fledged Linux environment within the container. This allows the application to run as a self-contained unit isolated from the rest of services/applications of the BMC 202. This may result in large resource utilization, as the container image can be 100 MB or more in size and consumes considerable runtime memory as well.

With containerization, the BMC 202 does not need to manage resources for the applications. Instead, the container runtimes like LXC or systemd-nspawn handle resource allocation and isolation for the containers.

To optimize resource usage, the relatively lightweight systemd-nspawn containers can be utilized on the BMC 202 instead of full LXC containers. To enable networking access for the application, the service manager 246 sets up a Linux bridge device or network on the BMC 202 which allows connectivity between the containerized service/application 252-1 and the host IPMI service 212 or REDFISH service 222 APIs needed for communication. As long as the service/application 252-1 (a third party application) adheres to the standardized REST APIs exposed by the BMC 202, the container approach allows securely deploying potentially unstable or untrusted code without risk of compromising critical system services running on the base OS hosted in the read-only partition 472.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operating a baseboard management controller (BMC), comprising:
receiving, via an application programming interface (API) at the BMC, a package management request for managing a software component of the BMC;
determining, by a package management service of the BMC, whether a software package for the software component is an updatable package to be stored on a read-write partition of a storage of the BMC; and
when the software package is the updatable package, managing the software component according to the package management request.

2. The method of claim 1, wherein managing the software component is removing the software component.

3. The method of claim 1, wherein managing the software component is updating or installing the software component.

4. The method of claim 3, further comprising obtaining the software package for the software component from a cloud storage.

5. The method of claim 4, further comprising verifying the authenticity and integrity of the software package using a package security service before performing the managing step.

6. The method of claim 5, wherein the verifying step comprises checking digital signatures and hashes associated with the software package.

7. The method of claim 4, further comprising ascertaining dependencies for the software package, and managing the dependencies via the package management service during the managing step.

8. The method of claim 7, wherein the managing the dependencies includes fetching any missing dependencies from a URL specified by the software package.

9. The method of claim 4, further comprising:
parsing metadata of the software package to determine dependency and license requirements.

10. The method of claim 9, wherein the parsing the metadata includes determining installation paths and system resources required for the software component according to information encapsulated in the software package.

11. The method of claim 1, wherein the software component is a third-party application, and the managing step includes deploying the third-party application in a segregated containerized environment within the BMC.

12. The method of claim 11, wherein the segregated containerized environment is managed via one of a Linux container (LXC) or a systemd-nspawn container runtime.

13. The method of claim 1, wherein the API is REDFISH compliant.

14. The method of claim 13, wherein the API provides OEM-specific extensions for additional functionalities beyond a standard model.

15. The method of claim 1, wherein the software package is stored on a cloud storage, wherein the managing the software component includes checking if an update of the software package is available from the cloud storage.

16. The method of claim 15, further comprising: when the update of the software package is available, automatically updating the software component on the BMC based on the update of the software package.

17. A baseboard management controller (BMC), comprising:
a memory; and
at least one processor coupled to the memory and configured to:
receive, via an application programming interface (API) at the BMC, a package management request for managing a software component of the BMC;
determine, by a package management service of the BMC, whether a software package for the software component is an updatable package to be stored on a read-write partition of the memory; and
when the software package is the updatable package, manage the software component according to the package management request.

18. The BMC of claim 17, wherein to manage the software component, the at least one processor is configured to remove the software component.

19. The BMC of claim 17, wherein to manage the software component, the at least one processor is configured to update or install the software component.

20. The BMC of claim 19, wherein the at least one processor is further configured to obtain the software package for the software component from a cloud storage.
